(19) United States
(12) Patent Application Publication
(10) Pub. No.: US 2011/0154739 A1
(43) Pub. Date: Jun. 30, 2011

(54) DEVICE WITH PROTECTION NET AND ASSEMBLY PROCEDURE SUITABLE AS BARRIER FOR ALL KINDS OF OPENINGS

(76) Inventor: Andrea Luisa GRUN, Ciudad Autonoma de Buenos Aires (AR)

(21) Appl. No.: 12/649,587

(22) Filed: Dec. 30, 2009

(51) Int. Cl. E04B 1/92; E06B 3/26; E06B 9/01

(52) U.S. Cl. 49/50; 52/202; 52/741.3

(57) ABSTRACT

This invention refers to a device with protection net and assembly procedure, suitable as a barrier for every kind of opening. It uses profiles especially designed and made up of plastic material (polyamide) with fiberglass, thus allowing mass production and easy handling. It also counts on assembly and tie means integrally related to a safety mesh-like net to be used as a retaining barrier in balconies, terraces, windows, and stairways preferably. It will reduce the risk of children and/or careless people falls in a safe, economical and esthetical manner.

### FIELD OF THE INVENTION

This invention corresponds to a protection device composed of a woven mesh or protection net associated to a number of plastic profiles (polyamide with fiberglass) with special tie means suitable mainly as a barrier in balconies, terraces, windows, staircases and mezzanines, which will secure you, in a safety, economic and esthetic manner, a risk reduction of children and/or careless people as well as pets falls through all kind of openings.

### BACKGROUND OF THE PRIOR ART

As regards previous devices, there are plastic and/or metallic weaves, or plastic and glass plate's applications which are placed against the window or balcony openings; all of them aimed at preventing people, especially kids, from falling.

Among the problems and limitations found in the plastic and metallic nets devices, the following can be mentioned: lack of visibility that such materials cause, lack of esthetics when having elements which are not tightened all along the surface, and especially the installation efficiency, lack of safety due to low endurance or poor mesh or net anchorages used. Besides, the installation of these weaves must be carried out by specialized personnel since special tools are needed; thus, raising the installation costs of said protection weaves.

As regards clear plastic or glass plates devices, their cost is quite high, plus the disadvantage of limiting the openings, which does not allow the air to flow.

Another similar protection device consists of installing a net or mesh tightened by means of a rope in the perimeter threaded to the same net or mesh; once the rope is tightened, that action makes the whole net or mesh to tighten. This rope is attached with ordinary fixing elements (staples, hook screws, etc), and in order to tighten it, a manual force is applied if there is no other traction element to count on.

One of the drawbacks of this kind of application is the sum of risk factors such as: net or mesh highly tightened; rope in the perimeter, from which safety and net performance depend on, scarcely tightened; fixing elements failure, whether individually or collectively; anchorages ageing or rust; incorrectly anchorages lineup causing an unsatisfactory result.

There is also another device composed of a mesh-like net made up of threads forming a large quantity of squares, and of profiles, mainly the “L” ones, fastening the opening. A tightening element like a wire bended as a “U” used as cotter pin, which is inserted in each square of the mesh-like net edge, will be put into existing holes along the fastening profiles mentioned, so as to enable the tightening of the mesh-like net. Aluminum from profiles may be selected among raw aluminum, anodized aluminum and/or oven-painted aluminum.

One of the drawbacks consists of using a wire-like tightening element and metallic profiles which may become a risk of hurting, pricking or scratching for kids and adults who have access to those installations.

In addition, the risk of having sharp edges which may really hurt users of this device as well as damage the net.

Another disadvantage as regards installation with aluminum profiles is that qualified labor is used for a perfect assembly in the disposition and lineup of the profiles as well as in the adjustment of the tightening elements of the net, resulting in higher costs and the limitation of not finding qualified labor in the place you need the device.

### SUMMARY OF THE INVENTION

The device with protection net of this invention comprises a mesh-like net that is preferably available in clear or white material formed by monofilament threads outlining mono-threads and multi-threads knotless-woven, high tenacity and endurance “raschel”-like mesh that make up a plurality of rhombus, which is installed in the whole open surface to be protected. One of the advantages of the abovementioned net is that it requires neither cleaning, nor painting and that said net guarantees a perfect view through it; it also achieves an undistorted appearance of the apartment or house and does not diminish the room light.

Its endurance is guaranteed by the absolute weave's discontinuity, in such a way that a possible breakage is interrupted in the thermo-sealed or thermo-fused knot next to the mesh, allowing its simple repair.

Installation is simple thanks to the special design of the profile; the necessary quantity is used in relation to the surface size to be protected. They are injected with a plastic material (fiberglass reinforced polyamide) and have a space described by a “guide” line in between “tie means”. This will enable the fastening of said profiles, through screws, wooden pegs and tie means incorporated to said profile and that will be fixed to the structure (floors/flagstones/lintels, etc.) by safe wooden bits so as to achieve a perfect assembly of the mesh-like net.

The net or mesh will be securely anchored to the profile in any position as required by the site to be protected thanks to the “anchor”-like tie means design that, due to its morphology, may be placed in all possible positions and directions ensuring, in all cases, that there is no way the net might “untie”.

Among the “tie means” there is a space that will allow drilling the profile wherever convenient, according to the surface requirements or restrictions to which it shall be stuck.

The proposed device has the following advantages:

It has profiles made of a plastic material (polymeric material) with fiberglass components allowing a condition of mass production and easy handling.

Profiles are installed in any position, it does not matter which, developing different configurations based on the surface to be protected, and avoiding, due to its morphology, that the net slides and gets untied.

Profiles may be dyed with the colors of the walls in order to obtain the esthetic characteristics of the room to be protected.

Easy installation due to the fewer number of pieces in its assembly.

Saving on raw material, product production and logistics as it is marketed in a “Kit” of in situ assembly installation.

Easy removal in the event of urgencies, thus enabling the access firefighters with telescopic ladders and/or paramedics.

It offers the widest mechanical endurance of the net as said net distributes its strength in a uniform, complete and radial way.

It does not have wrong side; the ending is tidy and well-ended.

### BRIEF DESCRIPTION OF THE DRAWINGS

In order to render the object of the invention more intelligible, it has been illustrated by three diagrammatic figures, in its preferred ways, which assume an illustrative example feature, as follows:

FIG. 1 shows a perspective view of the opening frame over which the device of the protection net of the invention is applied.

FIG. 2 shows a perspective view of the injected plastic profile, depicting the upper face of the profile.

FIG. 3 shows a perspective view of the injected plastic profile, depicting the lower face of the profile.

### DETAILED DESCRIPTION OF THE INVENTION

In all the figures, the same reference numbers state equal or relevant elements, which are as follows:
1. Profile.
2. Opening frame.
3. Upper face.
4. Lower face.
5. Flat region with longitudinal notches (5′) to place and drill with fastening means (12).
6. Nicks.
7. Tie means.
8. Arms
9. Net or mesh.
10. Tightness central ribs.
11. Tightness ribs placed on the lower face (4).
12. Fastening means (screws—wooden pegs).

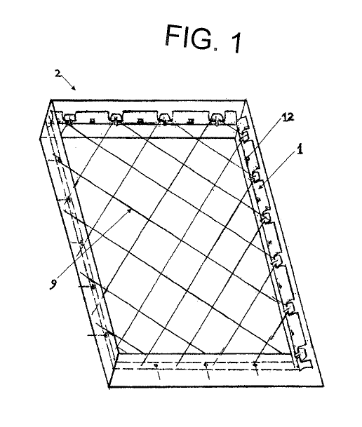

In said FIG. 1 there appears the frame 2 over which the mesh-like net 9 is held through the use of its assembly made up of a set of profiles 1 with at least a flat region (5) with longitudinal notches (5′) to place and drill with fastening means (12), with multiple nicks (6) evenly apart among them to place tie means (7) in order to tighten and stretch said net (9), with a simple tie in them. FIG. 1 shows the use of the tightening technique by being tied over each tie means 7.

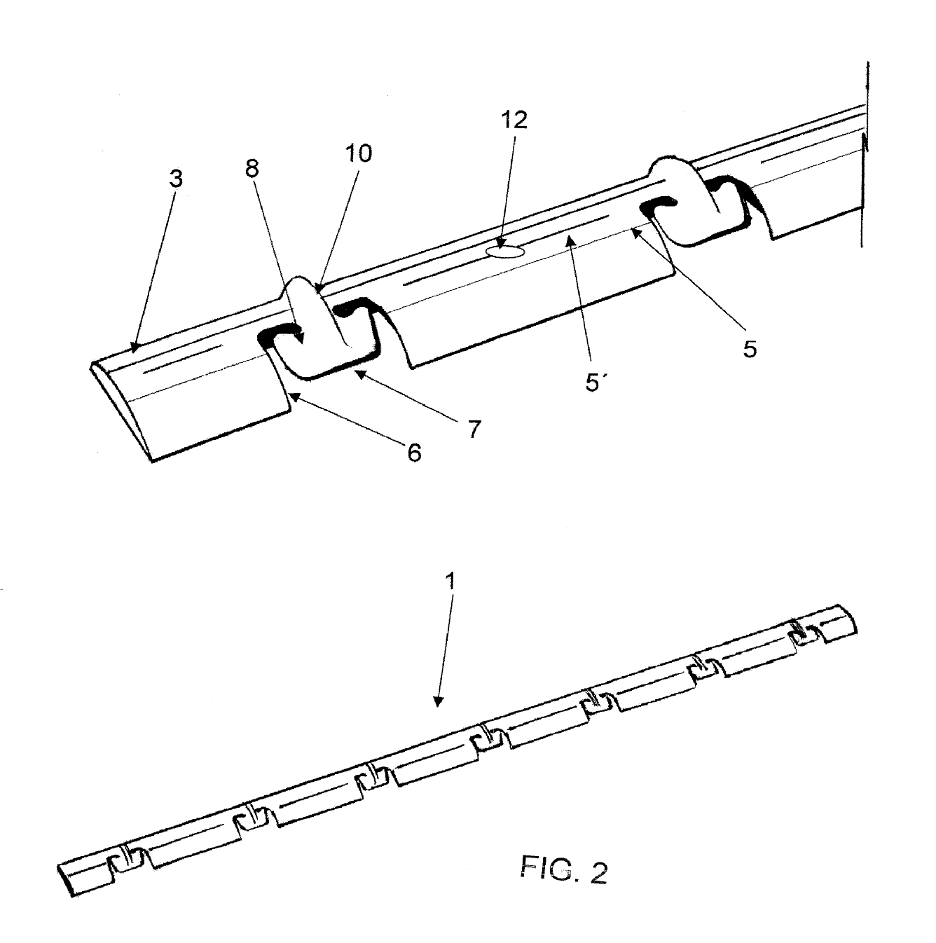

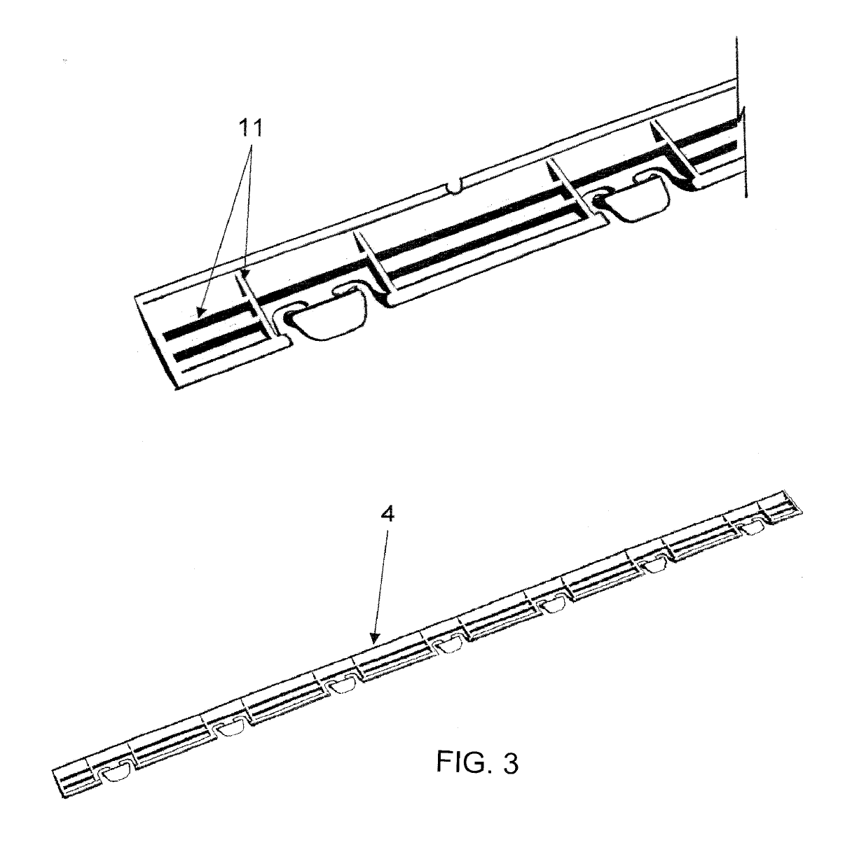

FIGS. 2 and 3 clearly shows the profiles features (1) which are outlined by long-shaped mono-pieces, of convex cross section (convex) in its upper face and with at least a flat region with longitudinal notches (5′) to place and drill with fastening means (12); multiple nicks (6) evenly located apart among them along said profile, which are entirely shown to the tie means (7) of said net (9); said tie means (7) are double hooks similar, in its morphology, to an anchor formed by nail-shaped arms (8) with a central rib giving tightness (10).

The tie means have—as regards the upper face—an upwards concave surface related to their central rib located at the middle part arranged in downwards concave way.

They also have, on the surface of the profile lower face, multiple ribs distributed in a longitudinal and a transverse way in order to render the structure of such profile more tightness.

The fact that the tie means of the protection net constitutes an integral part of the same profile is a very important technical feature.

The assembly procedure of the device in the opening to be protected basically comprises the following stages:

a) Put the profiles (1), preferably 0.50 cm long, from the ends towards the center completing the four sides (high, low, and opening or frame sides) (2), allocate the difference among profiles (if any) and complete by cutting a piece of profile to complete same, following the sequence of the tie means (7); b) Fix the profile sections to wall with at least three screws (12) per section by placing one screw (12) in each end and a third one in the middle, choosing freely the spot where to drill the profile into the wall in the sections between the tie means (7), c) place the net (9) by introducing each rhombus by the vertex in the relevant tie means (7) located at the profile and especially designed to that end and stretching the net so that it remains tight enough and d) cut out the remaining net (9).

We hereby state that the above mentioned and illustrated procedure is just a preferable manner of putting into practice this invention and shall be considered as included under its scope. Any other practice in line with the claims described hereinafter and any term therein referring to position, location and/or shape shall be construed as being the claimed device in normal position and/on adapted.

Being the nature and scope of the invention hereinabove described and represented, and being so the manner the invention has to be put into practice, we hereby claim the following as our exclusive right and ownership.

What is claimed is:

1. A protection net device suitable as a barrier for openings, balconies, terraces, windows, staircases, or mezzanines surfaces, the protection net device comprising:
a) a plurality of profiles, each profile having an upper face and a lower face, wherein the profiles adapt to the surface to be protected defining an open frame;
b) a mesh-like net covering the open frame, wherein the mesh-like net is made up of clear or white nylon and discontinuous weave, wherein the mesh-like net is formed by monofilament threads outlining mono-threads and multi-threads which form a series of rhombus;
wherein the profiles are long-shaped mono-pieces of convex cross section in the upper face with at least one flat region with longitudinal notches for positioning and drilling with fastening means;
wherein said profile comprises multiple equidistant nicks all along, which is projected as an integral part of the profile to tie means of the net;
wherein said tie means are double hooks having nail-shaped arms with a central rib intended to grant tightness.

2. The protection net device according to claim 1, wherein the tie means include an upwards concave surface related to their central rib located at the middle part placed in downwards concave way.

3. The protection device according to claim 1, wherein the profile lower face includes multiple ribs distributed in a longitudinal and a transverse way in order to render the structure of such profile more tightness.

4. The protection device according to claim 1, wherein the profile is made of an injected plastic material.

5. The protection device according to claim 4, wherein the injected plastic material is a fiberglass reinforced polyamide.

6. A protection net device suitable as a barrier for openings, balconies, terraces, windows, staircases, or mezzanines surfaces, the protection net device comprising:
a) a plurality of profiles, each profile having a convex cross section, an upper face, and a lower face, wherein the profiles adapt to the surface to be protected defining an open frame;
b) a mesh-like net covering the open frame, wherein the mesh-like net is made up of clear or white nylon and discontinuous weave, wherein the mesh-like net is formed by monofilament threads outlining mono-threads and multi-threads which form a series of rhombus;
wherein each profile includes in the upper face:
a flat region with longitudinal notches for attaching fastening means,
a plurality of nicks evenly apart among the length of the profile,
tie means placed inside the nicks to tighten and stretch the mesh-like net,
wherein each profile includes in the lower face:
a plurality of ribs evenly apart among the length of the profile,
wherein the tie-means are an integral part of the profiles.

7. A process to protect an opening on a surface, the process comprising the steps of:
a) providing a protection net device comprising:
a plurality of profiles, each profile having a convex cross section, an upper face, and a lower face, wherein the profiles adapt to the surface to be protected defining an open frame;
a mesh-like net covering the open frame, wherein the mesh-like net is made up of clear or white nylon and discontinuous weave, wherein the mesh-like net is formed by monofilament threads outlining mono-threads and multi-threads which form a series of rhombus;
wherein each profile includes in the upper face:
a flat region with longitudinal notches for attaching fastening means,
a plurality of nicks evenly apart among the length of the profile,
tie means placed inside the nicks to tighten and stretch the mesh-like net,
wherein each profile includes in the lower face:
a plurality of ribs evenly apart among the length of the profile,
wherein the tie-means are an integral part of the profiles.
b) forming the open frame by placing the plurality of profiles among the sides of the opening to be protected;
c) attaching the profile to the surface by placing the fastening means into the longitudinal notches of the profiles;
d) placing the mesh-like net into the open frame by introducing each rhombus by its vertex in the adjacent tie means located at the profile;
e) stretching the mesh-like net.
